(19) United States
(12) Patent Application Publication
(10) Pub. No.: US 2014/0104226 A1
(43) Pub. Date: Apr. 17, 2014

(54) APPARATUS AND METHOD OF CONTROLLING CAPACITANCE DETECTION, AND TOUCHSCREEN APPARATUS

(71) Applicant: SAMSUNG ELECTRO-MECHANICS CO., LTD., Suwon (KR)

(72) Inventors: Sang Ho LEE, Suwon (KR); Byeong Hak JO, Suwon (KR); Kyung Hee HONG, Suwon (KR); Hyun Suk LEE, Suwon (KR); Yong Il KWON, Suwon (KR); Tah Joon PARK, Suwon (KR)

(73) Assignee: SAMSUNG ELECTRO-MECHANICS CO., LTD., Suwon (KR)

(21) Appl. No.: 13/751,943

(22) Filed: Jan. 28, 2013

(30) Foreign Application Priority Data
Oct. 12, 2012 (KR) 10-2012-0113815

(51) Int. Cl. G06F 3/044

(52) U.S. Cl. CPC G06F 3/044
USPC 345/174

(57) ABSTRACT

There are provided an apparatus and a method of controlling capacitance detection, and a touchscreen apparatus. The apparatus includes: a driving circuit unit providing driving signals including a preset number of driving pulses to a plurality of respective driving electrodes of a panel unit; a detecting circuit unit removing electrical noise from a first voltage corresponding to a capacitance change in the panel unit when the electrical noise is included in the first voltage; and a controlling unit controlling the driving circuit unit to generate an additional driving pulse when the electrical noise is included in the first voltage.

### CROSS-REFERENCE TO RELATED APPLICATIONS

This application claims the priority of Korean Patent Application No. 10-2012-0113815 filed on Oct. 12, 2012, in the Korean Intellectual Property Office, the disclosure of which is incorporated herein by reference.

### BACKGROUND OF THE INVENTION

1. Field of the Invention

The present invention relates to an apparatus and a method of controlling capacitance detection, and a touchscreen apparatus, having improved capacitance detection performance by removing electrical noise to compensate for signal loss.

2. Description of the Related Art

In general, a touch sensing apparatus such as a touchscreen, a touch pad, or the like, an input means attached to a display apparatus to provide an intuitive input method to a user, has recently been widely used in various electronic devices such as cellular phones, personal digital assistants (PDAs), navigation devices, and the like. Particularly, as the demand for smartphones has recently increased, the use of a touchscreen as a touch sensing apparatus capable of providing various input methods in a limited form factor has correspondingly increased.

Touchscreens used in portable devices may mainly be divided into resistive type touchscreens and capacitive type touchscreens according to a method of sensing a touch input implemented therein. Here, the capacitive type touchscreen has advantages in that it has a relatively long lifespan and various input methods and gestures may be easily used therewith, such that the use thereof has increased. Particularly, capacitive type touchscreens may more easily allow for a multi-touch interface as compared with resistive type touchscreens, such that they are widely used in devices such as smartphones, and the like.

Capacitive type touchscreens include a plurality of electrodes having a predetermined pattern and defining a plurality of nodes in which a capacitance changes are generated by a touch input. In the plurality of nodes distributed on a two-dimensional plane, a self-capacitance or mutual-capacitance change is generated by the touch input. A coordinate of the touch input may be calculated by applying a weighted average method, or the like, to the capacitance change generated in the plurality of nodes. In order to accurately calculate the coordinate of the touch input, a technology capable of accurately sensing the capacitance change generated by the touch input is required. However, in the case in which electrical noise is generated in a wireless communications module, a display apparatus, or the like, a capacitance change may be hindered from being accurately sensed.

In addition, in the case of removing electrical noise, a signal may be lost altogether, with the removal of the electrical noise.

The following Patent Document 1, which relates to a circuit and a method of measuring capacitance of a touch sensor, does not disclose a feature of comparing a voltage charged in a capacitor with a predetermined reference voltage from a capacitance change generated in the touch sensor and removing a capacitance change due to noise from the comparison result.

In addition, the following Patent Document 2, which relates to a circuit for measuring capacitance, only discloses a feature of canceling an offset by using a plurality of switches, and does not disclose a feature of removing a capacitance change due to noise.

### RELATED ART DOCUMENT

(Patent Document 1) Korean Patent Laid-Open Publication No. 10-2011-0080254
(Patent Document 2) US Patent Laid-Open Publication No. US2011/0242048

### SUMMARY OF THE INVENTION

An aspect of the present invention provides an apparatus and a method of controlling capacitance detection, and a touchscreen apparatus having improved capacitance detection performance by removing electrical noise to compensate for signal loss.

According to an aspect of the present invention, there is provided an apparatus for controlling capacitance detection, the apparatus including: a driving circuit unit providing driving signals including a preset number of driving pulses to a plurality of respective driving electrodes of a panel unit; a detecting circuit unit removing electrical noise from a first voltage corresponding to a capacitance change in the panel unit when the electrical noise is included in the first voltage; and a controlling unit controlling the driving circuit unit to generate an additional driving pulse when the electrical noise is included in the first voltage.

The controlling unit may provide a driving line reset signal delayed by an amount of time corresponding to the additional driving pulse to the detecting circuit unit.

According to another aspect of the present invention, there is provided a method for controlling capacitance detection, the method including: generating, by a driving circuit unit, driving signals including a preset number of driving pulses for a plurality of respective driving electrodes of a panel unit and providing the generated driving signals to the panel unit, and detecting, by a detecting circuit unit, a first voltage corresponding to a capacitance change generated in a sensing electrode of the panel unit; determining, by the detecting circuit unit, whether or not electrical noise is included in the first voltage; and controlling, by a controlling unit, the driving circuit unit to generate an additional driving pulse when the electrical noise is included in the first voltage.

The method may further include providing, by the controlling unit, a driving line reset signal delayed by an amount of time corresponding to the additional driving pulse to the detecting circuit unit.

The detecting of the first voltage may include: charging, by a buffer unit, the first voltage corresponding to the capacitance change generated in the sensing electrode of the panel unit; comparing, by a comparing circuit unit, a level of the first voltage with a level of a preset reference voltage; and controlling, by a noise removing unit including a plurality of noise removing switches operating according to a comparison output signal of the comparing circuit unit, operations of the plurality of respective noise removing switches so as to allow the first voltage charged in a first capacitor to be discharged when the level of the first voltage is higher than the level of the reference voltage.

The comparing of the level of the first voltage with a level of the preset reference voltage may include: comparing the level of the first voltage with a level of a preset first reference voltage; and comparing the level of the first voltage with a level of a preset second reference voltage.

The detecting of the first voltage may further include integrating, in an integration circuit unit including a second capacitor in which a second voltage from the buffer unit is charged, a signal from which the electrical noise is removed by the noise removing unit.

The method may further include determining, by a signal processing unit, a touch input based on the second voltage of the integration circuit unit.

According to another aspect of the present invention, there is provided a touchscreen apparatus including: a panel unit including a plurality of driving electrodes and a plurality of sensing electrodes; a driving circuit unit providing driving signals including a preset number of driving pulses to the plurality of respective driving electrodes of the panel unit; a detecting circuit unit removing electrical noise from a first voltage corresponding to a capacitance change in the panel unit when the electrical noise is included in the first voltage; and a controlling unit controlling the driving circuit unit to generate an additional driving pulse when the electrical noise is included in the first voltage and providing a driving line reset signal delayed by an amount of time corresponding to the additional driving pulse to the detecting circuit unit.

The detecting circuit unit may integrate a second voltage from which the electrical noise is removed.

The detecting circuit unit may include: a buffer unit including a first capacitor in which the first voltage corresponding to the capacitance change generated in a sensing electrode of the panel unit is charged; a comparing circuit unit comparing a level of the first voltage from the buffer unit with a level of a preset reference voltage; and a noise removing unit including a plurality of noise removing switches operating according to a comparison output signal of the comparing circuit unit, the comparing circuit unit controlling operations of the plurality of respective noise removing switches so as to allow the first capacitor charged in the first capacitor to be discharged when the level of the first voltage is higher than the level of the reference voltage.

The comparing circuit unit may include: a first comparing circuit comparing the level of the first voltage with a level of a preset first reference voltage; and a second comparing circuit comparing the level of the first voltage with a level of a preset second reference voltage.

The detecting circuit unit may further include an integration circuit unit connected to the noise removing unit and including a second capacitor in which a second voltage from the buffer unit is charged.

The touchscreen apparatus may further include a signal processing unit determining a touch input from the second voltage of the integration circuit unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing an appearance of an electronic device including a touchscreen apparatus according to an embodiment of the present invention;

FIG. 2 is a block diagram of an apparatus for controlling capacitance detection according to the embodiment of the present invention;

FIG. 3 is a detailed circuit diagram of a circuit for detecting capacitance according to the embodiment of the present invention;

FIG. 4 is a view showing the touchscreen apparatus according to the embodiment of the present invention;

FIG. 5 is a flow chart of a method of controlling capacitance detection according to the embodiment of the present invention; and

FIGS. 6A through 8 are views describing the method of controlling capacitance detection according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

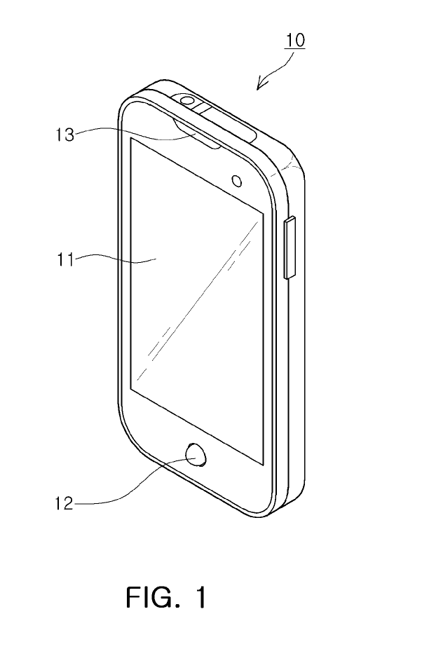

FIG. 1 is a perspective view showing an appearance of an electronic device including a touchscreen apparatus according to an embodiment of the present invention. Referring to FIG. 1, an electronic device 10 according to the embodiment of the present invention may include a display apparatus 11 for outputting a screen, an input unit 12, an audio unit 13 for outputting an audio signal, and a touchscreen apparatus integrated with the display apparatus 11.

As shown in FIG. 1, in the case of a mobile device, the touchscreen apparatus may be generally provided in a state in which it is integrated with the display apparatus and needs to have light transmissivity high enough to transmit a screen displayed by the display apparatus. Therefore, the touchscreen apparatus may be implemented by forming a sensing electrode on a base substrate formed of a transparent film material such as polyethylene telephtalate (PET), polycarbonate (PC), polyethersulfone (PES), polyimide (PI), or the like, using a transparent and electrically conductive material such as indium tin oxide (ITO), indium zinc oxide (IZO), zinc oxide (ZnO), carbon nano tube (CNT), or graphene. The display apparatus may include a wiring pattern disposed at a bezel region thereof, wherein the wiring pattern is connected to the sensing electrode formed of the transparent and conductive material. Since the wiring pattern is visually shielded by the bezel region, it may also be formed of a metal material such as silver (Ag), copper (Cu), or the like.

Since the touchscreen apparatus according to the embodiment of the present invention is operated in a capacitive scheme, the touchscreen apparatus may include a plurality of electrodes having a predetermined pattern. In addition, the touchscreen apparatus according to the embodiment of the present invention may include an apparatus for controlling capacitance detection in order to detect and control capacitance changes generated in the plurality of electrodes.

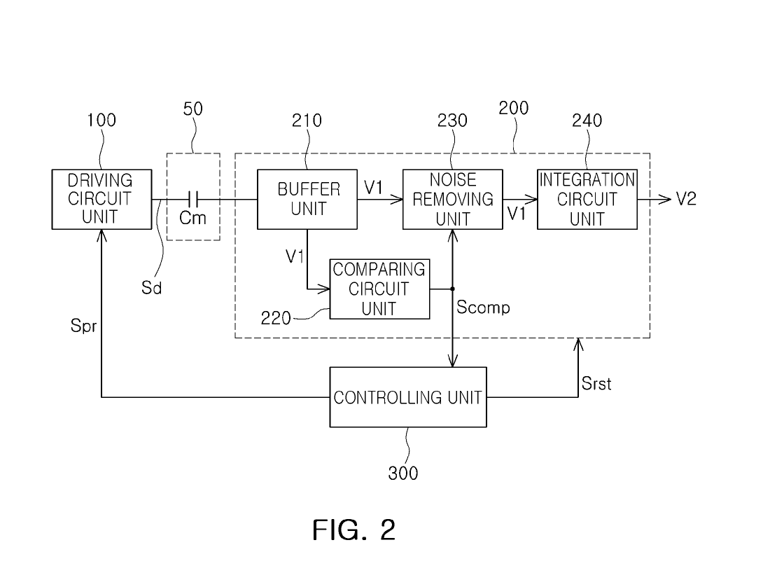

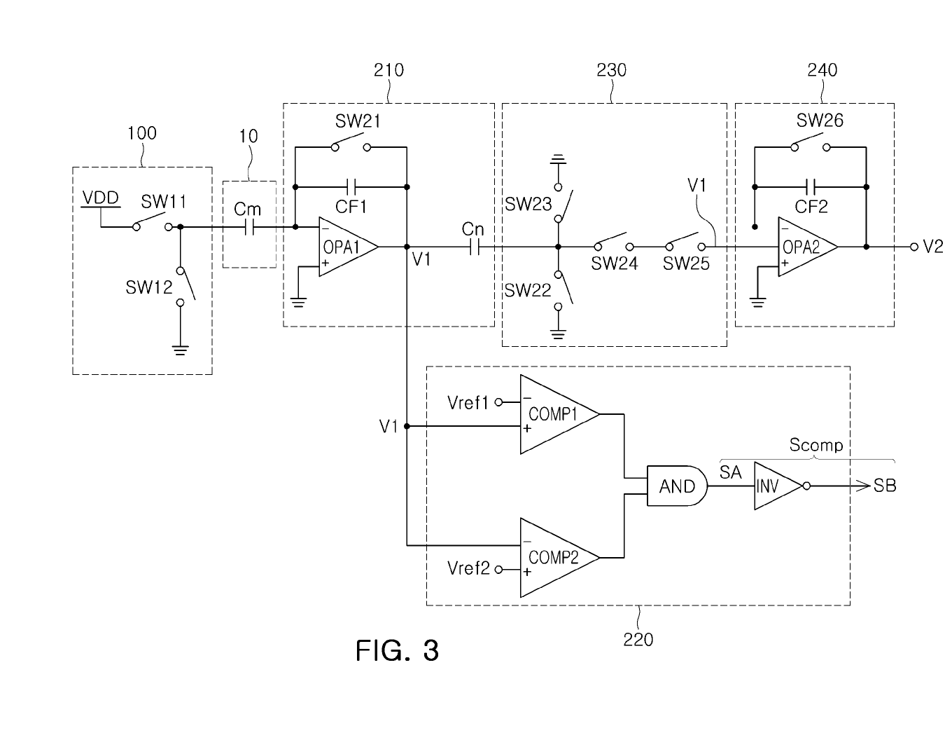

Hereinafter, an apparatus for controlling capacitance detection according to the embodiment of the present invention and an operation thereof will be described with reference to FIGS. 2 and 3.

FIG. 2 is a block diagram of an apparatus for controlling capacitance detection according to the embodiment of the present invention.

Referring to FIG. 2, the apparatus for controlling capacitance detection according to the embodiment of the present invention may include a driving circuit unit 100, a detecting circuit unit 200, and a controlling unit 300.

The driving circuit unit 100 may generate driving signals Sd including a preset number of driving pulses and provide the generated driving signals Sd to a plurality of respective driving electrodes of a panel unit 50.

Here, the driving signals Sd may be sequentially applied to the plurality of respective driving electrodes of the panel unit 50 at a preset time interval, and the driving signal Sd applied to one of the plurality of driving electrodes may include the preset number of pulses. The number of pulses may be associated with the number of sensing electrodes of the panel unit 50.

Here, the panel unit 50 may be shown as an equivalent capacitor Cm, which may correspond to mutual capacitance generated between a plurality of electrodes included in a capacitive type touchscreen.

Hereinafter, for convenience of explanation, the apparatus for controlling capacitance detection according to the present embodiment senses a capacitance change generated in the capacitance type touchscreen. In this case, it may be assumed that the capacitor Cm is a node capacitor in or from which charges are charged or discharged by changes in mutual capacitance generated in intersection points between the plurality of electrodes.

The detecting circuit unit 200 may remove electrical noise from a first voltage V1 corresponding to the capacitance change in the panel unit 50 when the electrical noise is included in the first voltage V1.

As an example, the detecting circuit unit 200 may include a buffer unit 210, a comparing circuit unit 220, and a noise removing unit 230, and may further include an integration circuit unit 240.

The buffer unit 210 may include a first capacitor in which the first voltage corresponding to the capacitance change generated in the sensing electrode of the panel unit 50 is charged.

The comparing circuit unit 220 may compare a level of the first voltage V1 from the buffer unit 210 with a level of a preset reference voltage and provide a comparison output signal Scomp corresponding to a result of the comparison to the noise removing unit 230 and the controlling unit 300.

Here, the comparison output signal Scomp may have a preset logic level (a high level or a low level) according to whether or not the level of the first voltage V1 is higher than the level of the reference voltage.

The noise removing unit 230 may include a plurality of noise removing switches operated according to the comparison output signal Scomp of the comparing circuit unit 220.

Here, the plurality of noise removing switches may be operated to discharge the first voltage V1 charged in the first capacitor or transfer the first voltage V1 to the integration circuit unit 240 according to the comparison output signal Scomp.

In addition, the integration circuit unit 240 may be connected to the noise removing unit 230 and include a second capacitor in which the first voltage V1 from the buffer unit 210 is charged.

The second capacitor is repeatedly charged with the first voltage V1 provided from the buffer unit 210, such that the integration circuit unit 240 provides a second voltage V2 rising in a stepwise manner.

Further, the controlling unit 300 may control the driving circuit unit 100 to generate an additional driving pulse when the electrical noise is included in the first voltage V1. Therefore, the driving circuit unit 100 may generate an additional pulse according to a control signal Spr of the controlling unit 300 commanding the generation of the additional driving pulse.

In addition, the controlling unit 300 may provide a driving line reset signal Rrst delayed by an amount of time corresponding to the additional driving pulse to the detecting circuit unit 200.

Therefore, the detecting circuit unit 200 may be delayed by and amount of time corresponding to the additional driving pulse by the driving line reset signal Srst of the controlling unit 300 to thereby be reset.

For example, when one period of the driving pulse is 7 μsec, in the case in which instantaneous noise is generated twice in any driving line, the controlling unit 300 may control generation of two additional driving pulses and provide a reset signal Srst delayed by 14 μsec, corresponding to the two additional driving pulses, to the detecting circuit unit 200.

FIG. 3 is a detailed circuit diagram of a circuit for detecting capacitance according to the embodiment of the present invention.

Referring to FIG. 3, the circuit for detecting capacitance according to the embodiment of the present invention may include the driving circuit unit 100 and the detecting circuit unit 200, wherein the detecting circuit unit 200 may include the buffer unit 210, the comparing circuit unit 220, the noise removing unit 230, and the integration circuit unit 240, as described above.

Here, similar to FIG. 2, the capacitor Cm, an equivalent capacitor of the panel unit 50 of the capacitive type touchscreen, may correspond to the mutual capacitance generated between the plurality of electrodes included in the capacitive type touchscreen.

First, the driving circuit unit 100 may include two switches SW1 and SW2. Here, the switch SW1 may be connected to a node supplying a voltage VDD and a first node of a capacitor Cm. The switch SW2 may be connected to a ground terminal GND and the first node of the capacitor Cm.

Therefore, in the case in which the switch SW11 is turned on (closed), charges may be charged in the capacitor Cm by the voltage VDD, and in the case in which the switch SW12 is turned on, the charges charged in the capacitor Cm may be discharged. As a result, the switches SW11 and SW12 may be complementarily turned on and turned off so that they have different turn-on timings. Here, the buffer unit 210 may be connected to a second node of the capacitor Cm.

The buffer unit 210 may include an operational amplifier OPA1, a capacitor CF1, a capacitor Cn, and a switch SW21. The switch SW21 may be operated at the same period as that of the switch SW11. Therefore, during a time in which the switches SW 11 and SW21 are turned on and the switch SW12 is turned off, the capacitor Cm may be charged with charges by the voltage VDD, and the operational amplifier OPA1 may be reset. Meanwhile, during a time in which the switches SW11 and SW21 are turned off and the switch SW12 is turned on, the charges charged in the capacitor Cm may be transferred to the capacitor CF1. In this case, an output voltage V1 of the operational amplifier OPA1 may be represented by the following Equation 1.

$$V 1 = \frac{VDD * Cm}{CF 1} \qquad [ Equation 1 ]$$

As seen from Equation 1, the first voltage V1 of the buffer unit 210 may be determined according to a capacitance ratio between the capacitor Cm and the capacitor CF1. Therefore, the capacitor CF1 may be configured to have capacitance significantly higher than that of the capacitor Cm including target charges to be measured, thereby preventing the first voltage V1 of the buffer unit 210 from being saturated. Here, the first voltage V1 of the buffer unit 210 may be input to the comparing circuit unit 220 and the noise removing unit 230.

As shown in FIG. 3, the comparing circuit unit 220 may compare the first voltage V1 with the preset reference voltage and provide the comparison output signal Scomp corresponding to the result of the comparison to the noise removing unit 230 and the controlling unit 300.

As an example, the comparing circuit unit 220 may include a first comparing circuit COMP1 and a second comparing circuit COMP2. Here, the first comparing circuit COMP1 may compare the level of the first voltage V1 with a level of a preset first reference voltage Vref1. The second comparing circuit COMP2 may compare the level of the first voltage V1 with a level of a preset second reference voltage Vref2.

Output signals of the respective comparing circuits may be output to the noise removing unit 230 and the controlling unit 300 through a predetermined logic circuit. As an example, the output signal of the comparing circuit unit 220 may control turn-on/off of switches SW23 and SW25.

In an ideal case, the node capacitor Cm defined by the electrode of the capacitive type touchscreen may be charged by the voltage VDD of the driving circuit unit and have capacitance changed by a touch input. Here, the amount of a change in capacitance may be measured by the capacitor CF1 of the buffer unit 210 and be reflected in the first voltage V1. However, in the case in which electrical noise is introduced into the touchscreen for any reason, an undesired capacitance change may be generated in the capacitor Cm due to the electrical noise. In the case in which the capacitance change generated in the capacitor Cm due to the electrical noise is transferred to the first voltage V1 of the buffer unit 210 as it is, it may serve as an element in obstructing accurately determining the touch input.

Therefore, as described above, the comparing circuit unit 220 may compare the level of the first voltage V1 of the buffer unit 210 to each of the levels of the first and second reference voltages Vref1 and Vref2 to determine whether noise having a positive (+) component or noise having a negative (−) component is introduced.

Generally, the first voltage V1 appearing by switching operations of the driving circuit unit 100 and the buffer unit 210 may tend to be smoothly increased or decreased by repetition of charging and discharging of the charges. Therefore, in the case in which an instantaneously low voltage or high voltage is detected, it may be determined that the electrical noise is introduced to have an influence on the capacitor Cm.

The noise removing unit 230 may include a plurality of switches. Switches SW22, SW23, SW24, and SW25 included in the noise removing unit 230 may determine whether they remove the electrical noise from the first voltage V1 of the buffer unit 210 or transfer the first voltage V1 of the buffer unit 210 as it is to the integration circuit unit 240 according to whether or not the influence due to the electrical noise is reflected in the first voltage V1 of the buffer unit 210.

First, in the case in which the influence due to the electrical noise is not reflected in the first voltage V1, the first voltage V1 may always have a value higher than the first reference voltage Vref1 and lower than the second reference voltage Vref2. The level of the first reference voltage Vref1, a reference level for detecting the noise having the negative component, may have a negative sign, and the level of the second reference voltage Vref2, a reference level for detecting the noise having the positive component, may have a positive sign.

In the case in which the noise is not generated, since the first voltage V1 is set to be always lower than the second reference voltage Vref2 and higher than the first reference voltage Vref1, both of the output signals of the first and second comparing circuits COMP1 and COMP2 may have high (HIGH) values. Therefore, an output signal SA of an and-gate AND may also have a high (HIGH) value, and an output signal SB of an inverter INV may have a low (LOW) value. Here, the comparison output signal Scomp may include the output signal SA of the and-gate AND and the output signal SB of the inverter INV.

Here, the output signal SA of the and-gate AND may be connected to the switch SW25, and the output signal SB of the inverter INV may be connected to the switch SW23. Therefore, at the time of a normal operation in which the noise is not generated, the switch SW23 may be turned off (opened), and the switch SW25 may be turned on (short-circuited). As a result, the charges charged in the capacitor Cn may be input to the integration circuit unit 240, and the second voltage V2 output from the integration circuit unit 240 may be represented by the following Equation 2.

$$V 2 = \frac{V 1 * Cn}{CF 2} = \frac{VDD * Cm * Cn}{CF 1 * CF 2} \qquad [ Equation 2 ]$$

On the other hand, in the case in which the noise having the positive component is introduced, the charges charged in the capacitor Cn by the capacitor CF1 of the buffer unit 210 may be instantaneously decreased up to a value adjacent to 0V. Therefore, since a value lower than the level of the first reference voltage Vref1 appears in the first voltage V1, the first comparing circuit COMP1 may output the low (LOW) signal. Since the second comparing circuit COMP2 still outputs the high (HIHG) signal, the output signal SA) of the and-gate (AND) may become low (LOW), and the inverter INV may output the output signal SB having the high (HIGH) value.

Unlike this, in the case in which the noise having the negative component is introduced, the first voltage V1 of the buffer unit 210 may be instantaneously increased by the noise to thereby be saturated. Therefore, the first voltage V1 has a value higher than the level of the first reference voltage Vref1, such that the output signal of the first comparing circuit COMP1 may still have the high (HIGH) value; however, the second comparing circuit COMP2 may generate the output signal having the low (LOW) value. As a result, the output signal SA of the and-gate AND may also have the low (LOW) value, and the output signal SB of the inverter INV may have the high (HIGH) value.

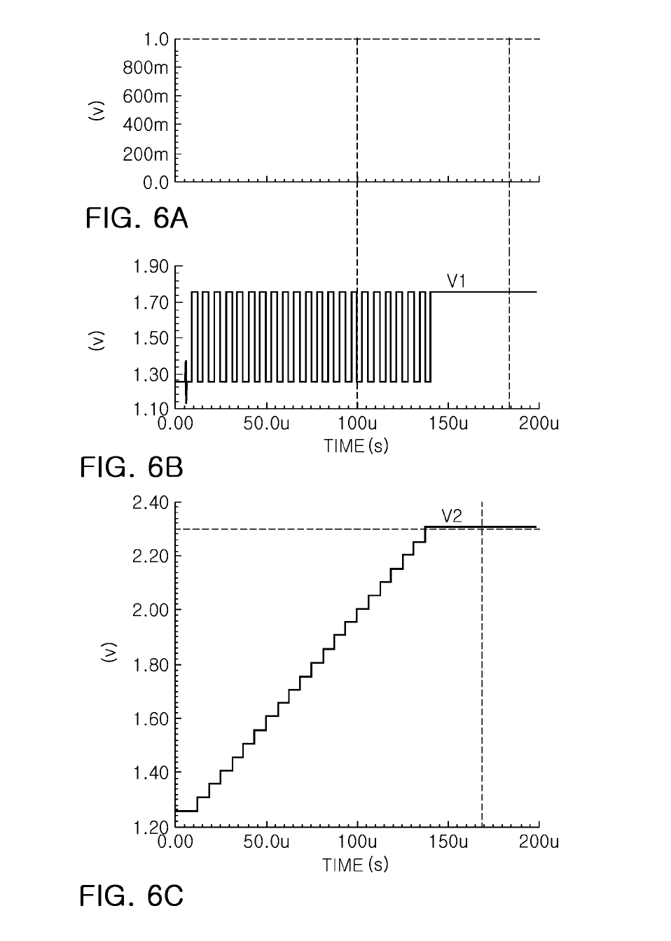

As described above, in both the case in which the noise having the positive component is introduced and the case in which the noise having the negative component is introduced, the output signal SA of the and-gate AND may also have the low (LOW) value, and the output signal SB of the inverter INV may have the high (HIGH) value. Therefore, the switch SW23 is turned on (short-circuited) and the switch SW25 is turned off (opened), such that the charges charged in the capacitor Cn by the capacitor CF1 of the buffer unit 210 may be discharged to the ground terminal. As described above, the capacitance change appearing by the instantaneous noise is removed, whereby the second voltage V2 generated by the integration circuit unit 240 may have a more stable value. A description thereof will be provided below with reference to FIGS. 6 through 8.

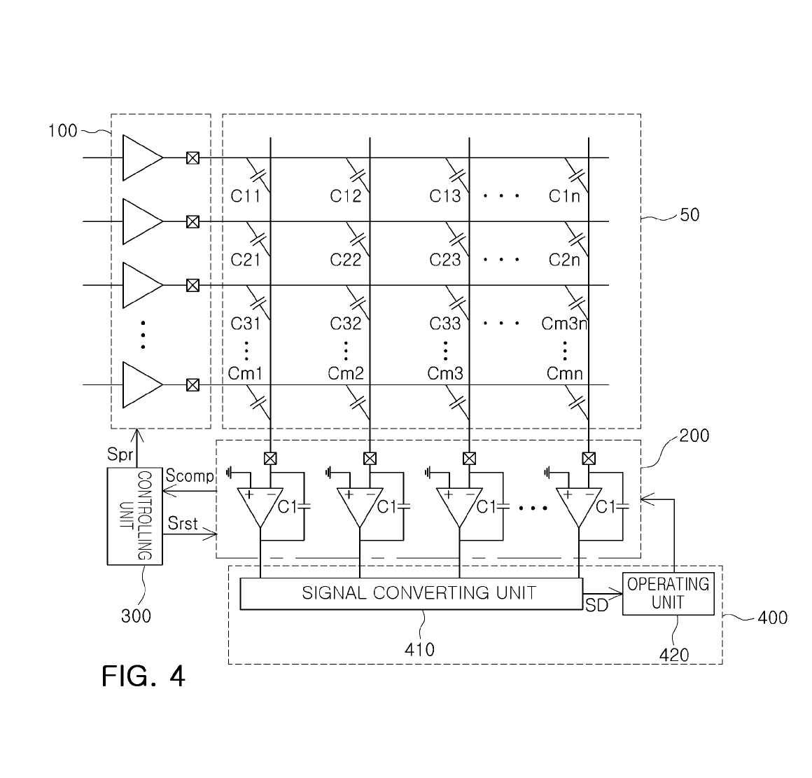

FIG. 4 is a view showing the touchscreen apparatus according to the embodiment of the present invention.

Referring to FIG. 4, the touchscreen apparatus according to the embodiment of the present invention may include the panel unit 50, the driving circuit unit 100, the detecting circuit unit 200, and the controlling unit 300, and may further include a signal processing unit 400.

The panel unit 50 may include a plurality of driving electrodes and a plurality of sensing electrodes. A description of a content overlapped with the above-mentioned content in a description of each of the driving circuit unit 100, the detecting circuit unit 200, and the controlling unit 300 will be omitted.

The panel unit 50 may include a plurality of first electrodes extended in a first axis direction (that is, a horizontal direction of FIG. 4) and a plurality of second electrodes extended in a second axis direction (that is, a vertical direction of FIG. 4).

Here, capacitance changes C11 to Cmn may be generated in intersection points between the first electrodes and the second electrodes. The capacitance changes C11 to Cmn generated in the intersection points between the first and second electrodes may be changes in mutual capacitance generated by driving signals applied to the first electrodes by the driving circuit unit 420. Here, the driving circuit unit 100, the detecting circuit unit 200, and the signal processing unit 400 may be implemented as a single integrated circuit (IC).

The driving circuit unit 100 may apply predetermined driving signals to the first electrodes of the panel unit 50. The driving signals may be square wave signals, sine wave signals, triangle wave signals, or the like, having a predetermined period and amplitude and may be sequentially applied to the plurality of respective first electrodes. Although the case in which circuits for generating and applying the driving signals are individually connected to the plurality of first electrodes, respectively, is shown in FIG. 4, a single driving signal generating circuit may also generate driving signals and apply the generated driving signals to the plurality of first electrodes, respectively, using a switching circuit.

The detecting circuit unit 200 may include the buffer unit 210, the comparing circuit unit 220, the noise removing unit 230, and the integration circuit unit 240, as shown in FIGS. 2 and 3 in order to sense the capacitance changes C11 to Cmn in the second electrodes.

Although the case in which the detecting circuit unit 200 includes integration circuits has been shown in FIG. 4 for simplification of explanation, each of the integration circuits may include at least one operational amplifier and a capacitor C1 having predetermined capacitance. An inverting input terminal of the operational amplifier may be connected to the second electrode to convert the capacitance changes C11 to Cmn into analog signals such as voltage signals and output the converted signals. In the case in which the driving signals are sequentially applied to the plurality of first electrodes, respectively, since the capacitance changes from the plurality of second electrodes may be simultaneously detected, the number of integrating circuits may correspond to the number (m) of second electrodes.

The signal processing unit 400 may include a signal converting unit 410 and an operating unit 420. The signal converting unit 410 may generate a digital signal SD from an analog signal generated by the integrating circuit. For example, the signal converting unit 410 may include a time to digital converter (TDC) circuit measuring a time at which the analog signal output in a voltage form by the detecting circuit unit 200 arrives at a level of a predetermined reference voltage and converting the measured time into the digital signal SD or an analog to digital converter (ADC) circuit measuring an amount by which a level of the analog signal output by the detecting circuit unit 200 is changed for a predetermined time and converting the change amount into the digital signal SD.

The operating unit 420 may determine a touch input applied to the panel unit 50 using the digital signal SD. As an example, the calculating unit 420 may determine the number, coordinates, gesture operations, or the like, of touch inputs applied to the panel unit 50.

Meanwhile, comparing the apparatus for controlling capacitance detection shown in FIGS. 2 and 3 and the touchscreen apparatus shown in FIG. 4 with each other, the node capacitors C11 to Cmn generated in the intersection points between the first and second electrodes may correspond to the capacitor Cm of FIGS. 2 and 3.

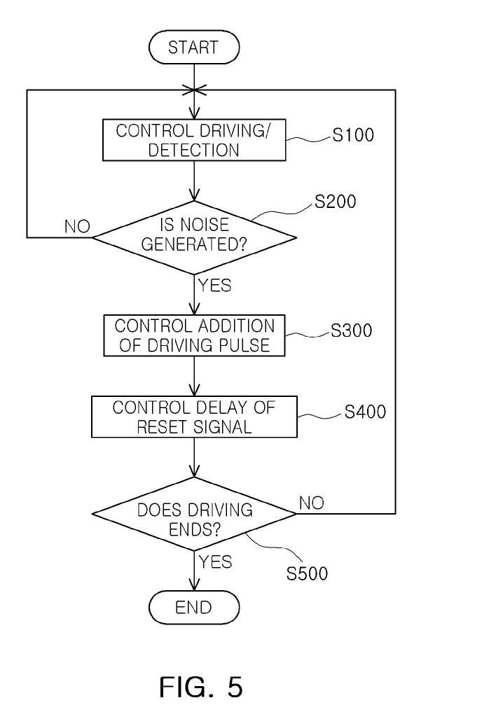

FIG. 5 is a flow chart of a method of controlling capacitance detection according to the embodiment of the present invention.

A description of the method of controlling capacitance detection according to the embodiment of the present invention is not limited to FIG. 5. That is, related operations may be described and understood with reference to FIGS. 1 through 8. In addition, a description of content overlapped with content described with reference to FIGS. 1 through 4 in a description of the method of controlling capacitance detection according to the embodiment of the present invention will be omitted.

Hereinafter, the method of controlling capacitance detection according to the embodiment of the present invention will be described with reference to FIG. 5. First, the driving circuit unit 100 may generate the driving signals having a preset number of driving pulses for each of the plurality of driving electrodes of the panel unit 50 and supply the generated driving signals to the panel unit 50, and the detecting circuit unit 200 may detect the first voltage V1 corresponding to the capacitance change generated in the sensing electrode of the panel unit 50 (S100).

As an example, describing a step of detecting the first voltage V1, the first voltage corresponding to the capacitance change generated in the sensing electrode of the panel unit 50 is charged in the buffer unit 210. The comparing circuit unit 220 compares the level of the first voltage V1 with the level of the preset reference voltage. In addition, in the noise removing unit 230 including the plurality of noise removing switches operated according to the comparison output signal Scomp of the comparing circuit unit 220, operations of the plurality of respective noise removing switches may be controlled so as to allow the first voltage V1 charged in the first capacitor to be discharged when the level of the first voltage V1 is higher than the level of the reference voltage.

In addition, describing a step of comparing the level of the first voltage V1 with the level of the reference voltage, the level of the first voltage V1 may be first compared with the level of the preset first reference voltage. Then, the level of the first voltage V1 may be compared with the level of the preset second reference voltage.

Further, the step of detecting the first voltage V1 may further include a step of integrating a signal from which electrical noise has been removed in the noise removing unit 230.

In this case, the integration circuit unit 240 including the second capacitor in which the first voltage from the buffer unit 210 is charged may integrate the signal from which the electrical noise has been removed in the noise removing unit 230.

Next, the detecting circuit unit 200 may determine whether or not the electrical noise is included in the first voltage V1 (S200).

Then, the controlling unit 300 may control the driving circuit unit 100 to generate an additional driving pulse when the electrical noise is included in the first voltage V1 (S300).

The controlling unit 300 may provide the driving line reset signal delayed by an amount of time corresponding to the additional driving pulse to the detecting circuit unit 200 (S400).

Then, whether or not the driving will end is determined, and the method of controlling capacitance detection according to the embodiment of the present invention proceeds to a first step in the case in which it is determined that the driving will not end and the driving ends in the case in which it is determined that the driving will end.

In addition, the method of controlling capacitance detection according to the embodiment of the present invention may further include a step of determining a touch input. In this case, the signal processing unit 400 may determine the touch input based on the second voltage V2 of the integration circuit unit 240.

FIGS. 6A through 8 are views describing the method of controlling capacitance detection according to the embodiment of the present invention.

First, FIGS. 6A through 6C show the first voltage V1 of the buffer unit 210 and the second voltage V2 of the integration circuit unit 240 in the case in which the noise is not introduced.

As shown in FIG. 6A, the noise does not appear at all. Therefore, as shown in FIG. 6B, the first voltage V1 of the buffer unit 210 has a stable waveform. Further, as shown in FIG. 6C, the second voltage V2 of the integration circuit unit 240 is sequentially increased to have a level of 2.3V in a time of about 170 μs.

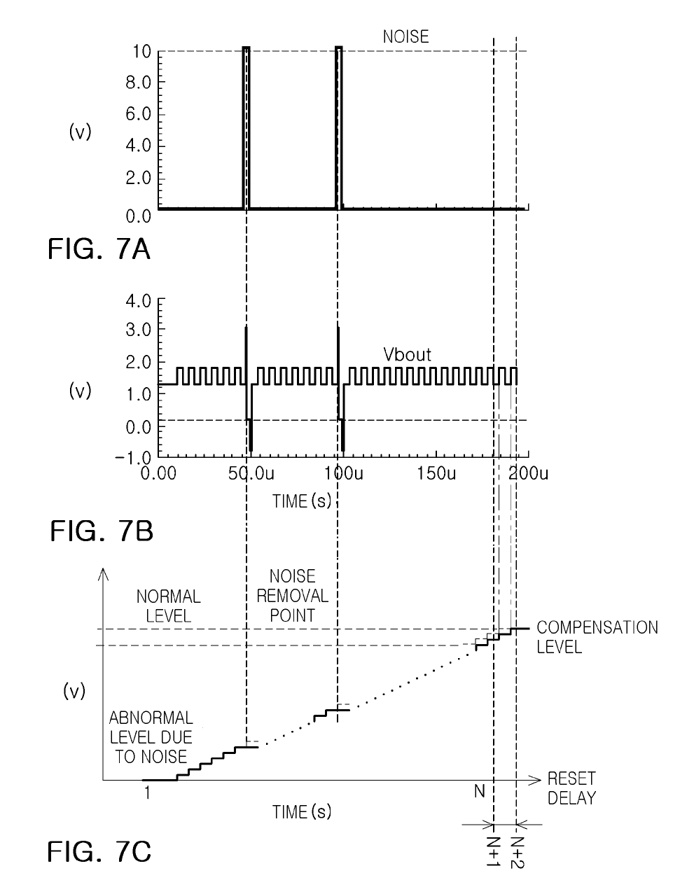

First, FIGS. 7A through 7C show the first voltage V1 of the buffer unit 210 and the second voltage V2 of the integration circuit unit 240 in the case in which the noise is introduced.

When the noise appears as shown in FIG. 7A, the first voltage V1 of the buffer unit 210 has a waveform in which pulses are removed at points in time at which the noise is generated and pulses having the number corresponding to the number of removed pulses are added at the last portion, as shown in FIG. 7B.

In addition, as shown in FIG. 7C, the second voltage V2 of the integration circuit unit 240 is sequentially increased and is not increased at a point in time in which the pulses are removed due to the noise, and is again increased by a level in which it is not increased, by the added pulses. As a result, the touch may be accurately detected without being affected by the removal of the pulse due to the noise.

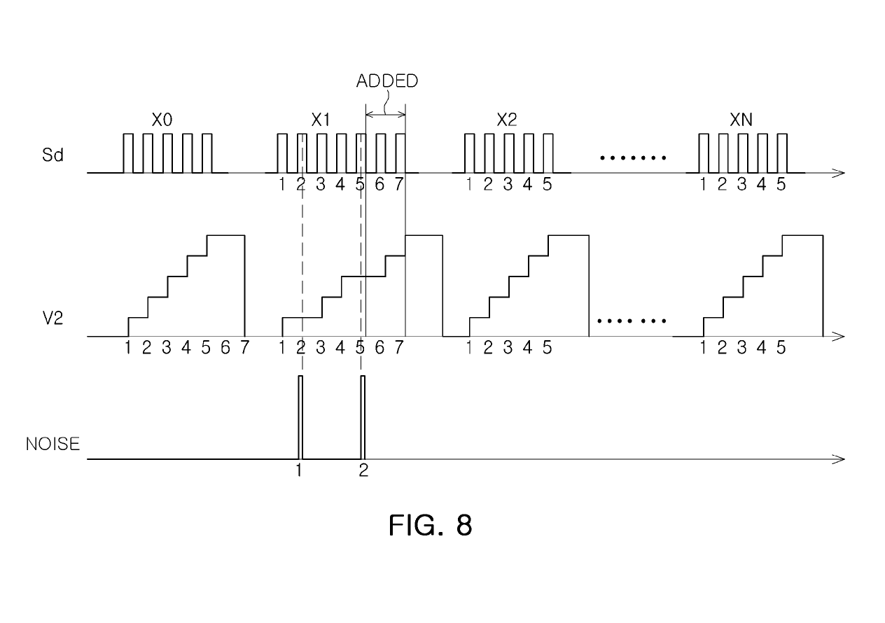

FIG. 8 shows the driving signal Sd and the waveform of the second voltage V2 output from the integration circuit unit 240 according to whether or not the noise is introduced, with respect to a plurality of X driving lines X0 and X1 to Xn.

Referring to FIG. 8, it was assumed that the number of driving pulses in one driving line is five. At the time of driving the driving lines X0, X2, and Xn, instantaneous noise is not present. An example in which instantaneous noise is generated twice at the time of driving the driving line X1 is described.

The controlling unit 300 may generate two additional driving pulses in a driving signal of a driving line X1 due to the instantaneous noise generated twice to generate a total of seven driving pulses and delays a reset time of the detecting circuit unit 200 by an amount of time corresponding to the added two pulses to allow seven accumulated operations to be performed. Therefore, the detected voltage is compensated for so as to be similar to a state in which it does not have the noise.

As set forth above, according to the embodiments of the present invention, signal loss generated in the case of removing the electrical noise is compensated for to prevent a malfunction due to the signal loss, whereby capacitance detection performance may be improved.

While the present invention has been shown and described in connection with the embodiments, it will be apparent to those skilled in the art that modifications and variations can be made without departing from the spirit and scope of the invention as defined by the appended claims.

What is claimed is:

1. An apparatus for controlling capacitance detection, the apparatus comprising:
a driving circuit unit providing driving signals including a preset number of driving pulses to a plurality of respective driving electrodes of a panel unit;
a detecting circuit unit removing electrical noise from a first voltage corresponding to a capacitance change in the panel unit when the electrical noise is included in the first voltage; and
a controlling unit controlling the driving circuit unit to generate an additional driving pulse when the electrical noise is included in the first voltage.

2. The apparatus of claim 1, wherein the detecting circuit unit integrates a second voltage from which the electrical noise is removed.

3. The apparatus of claim 1, wherein the controlling unit provides a driving line reset signal delayed by an amount of time corresponding to the additional driving pulse to the detecting circuit unit.

4. The apparatus of claim 1, wherein the detecting circuit unit includes:
a buffer unit including a first capacitor in which the first voltage corresponding to the capacitance change generated in a sensing electrode of the panel unit is charged;
a comparing circuit unit comparing a level of the first voltage from the buffer unit with a level of a preset reference voltage; and
a noise removing unit including a plurality of noise removing switches operating according to a comparison output signal of the comparing circuit unit,
the comparing circuit unit controlling operations of the plurality of respective noise removing switches so as to allow the first voltage charged in the first capacitor to be discharged when the level of the first voltage is higher than the level of the reference voltage.

5. The apparatus of claim 4, wherein the comparing circuit unit includes:
a first comparing circuit comparing the level of the first voltage with a level of a preset first reference voltage; and
a second comparing circuit comparing the level of the first voltage with a level of a preset second reference voltage.

6. The apparatus of claim 4, wherein the detecting circuit unit further includes an integration circuit unit connected to the noise removing unit and including a second capacitor in which a second voltage from the buffer unit is charged.

7. A method for controlling capacitance detection, the method comprising:
generating, by a driving circuit unit, driving signals including a preset number of driving pulses for a plurality of respective driving electrodes of a panel unit and providing the generated driving signals to the panel unit, and detecting, by a detecting circuit unit, a first voltage corresponding to a capacitance change generated in a sensing electrode of the panel unit;
determining, by the detecting circuit unit, whether or not electrical noise is included in the first voltage; and
controlling, by a controlling unit, the driving circuit unit to generate an additional driving pulse when the electrical noise is included in the first voltage.

8. The method of claim 7, further comprising providing, by the controlling unit, a driving line reset signal delayed by an amount of time corresponding to the additional driving pulse to the detecting circuit unit.

9. The method of claim 8, wherein the detecting of the first voltage includes:
charging, by a buffer unit, the first voltage corresponding to the capacitance change generated in the sensing electrode of the panel unit;
comparing, by a comparing circuit unit, a level of the first voltage with a level of a preset reference voltage; and
controlling, by a noise removing unit including a plurality of noise removing switches operating according to a comparison output signal of the comparing circuit unit, operations of the plurality of respective noise removing switches so as to allow the first voltage charged in a first capacitor to be discharged when the level of the first voltage is higher than the level of the reference voltage.

10. The method of claim 9, wherein the comparing of the level of the first voltage with a level of the preset reference voltage includes:
comparing the level of the first voltage with a level of a preset first reference voltage; and
comparing the level of the first voltage with a level of a preset second reference voltage.

11. The method of claim 9, wherein the detecting of the first voltage further includes integrating, in an integration circuit unit including a second capacitor in which a second voltage from the buffer unit is charged, a signal from which the electrical noise is removed by the noise removing unit.

12. The method of claim 11, further comprising determining, by a signal processing unit, a touch input based on the second voltage of the integration circuit unit.

13. A touchscreen apparatus comprising:
a panel unit including a plurality of driving electrodes and a plurality of sensing electrodes;
a driving circuit unit providing driving signals including a preset number of driving pulses to the plurality of respective driving electrodes of the panel unit;
a detecting circuit unit removing electrical noise from a first voltage corresponding to a capacitance change in the panel unit when the electrical noise is included in the first voltage; and
a controlling unit controlling the driving circuit unit to generate an additional driving pulse when the electrical noise is included in the first voltage and providing a driving line reset signal delayed by an amount of time corresponding to the additional driving pulse to the detecting circuit unit.

14. The touchscreen apparatus of claim 13, wherein the detecting circuit unit integrates a second voltage from which the electrical noise is removed.

15. The touchscreen apparatus of claim 13, wherein the detecting circuit unit includes:
a buffer unit including a first capacitor in which the first voltage corresponding to the capacitance change generated in a sensing electrode of the panel unit is charged;
a comparing circuit unit comparing a level of the first voltage from the buffer unit with a level of a preset reference voltage; and
a noise removing unit including a plurality of noise removing switches operating according to a comparison output signal of the comparing circuit unit,
the comparing circuit unit controlling operations of the plurality of respective noise removing switches so as to allow the first capacitor charged in the first capacitor to be discharged when the level of the first voltage is higher than the level of the reference voltage.

16. The touchscreen apparatus of claim 15, wherein the comparing circuit unit includes:
a first comparing circuit comparing the level of the first voltage with a level of a preset first reference voltage; and
a second comparing circuit comparing the level of the first voltage with a level of a preset second reference voltage.

17. The touchscreen apparatus of claim 15, wherein the detecting circuit unit further includes an integration circuit unit connected to the noise removing unit and including a second capacitor in which a second voltage from the buffer unit is charged.

18. The touchscreen apparatus of claim 17, further comprising a signal processing unit determining a touch input from the second voltage of the integration circuit unit.
